(19) United States
(12) Patent Application Publication
(10) Pub. No.: US 2021/0215127 A1
(43) Pub. Date: Jul. 15, 2021

(54) METHOD FOR MANUFACTURING ASSEMBLY, PARTS SET, METHOD FOR MANUFACTURING FUEL INJECTION PUMP, AND FUEL INJECTION PUMP

(71) Applicant: DENSO CORPORATION, Kariya-city (JP)

(72) Inventor: Daisuke KASHIWAGI, Kariya-city (JP)

(21) Appl. No.: 17/147,683

(22) Filed: Jan. 13, 2021

(30) Foreign Application Priority Data
Jan. 15, 2020 (JP) 2020-004097

(51) Int. Cl. F02M 59/48; F02M 21/02; F02M 37/00; F02M 37/04; F02M 55/04; F04B 9/04; F04B 11/00; F04B 19/00; F04B 35/01; F04B 39/12; F04B 53/14

(52) U.S. Cl. CPC F02M 59/48; F02M 21/0245; F02M 37/0041; F02M 37/046; F02M 55/04; F04B 9/042; F04B 53/16; F04B 19/00; F04B 35/01; F04B 39/122; F04B 39/123; F04B 39/125; F04B 53/143; F04B 11/0033

(57) ABSTRACT

An assembly includes a housing including a first assembly portion and a cover including a second assembly portion. One of the first assembly portion and the second assembly portion includes: (i) a small diameter inner circumferential wall, a large diameter inner circumferential wall, and an inner stepped portion; or (ii) a large diameter outer circumferential wall, a small diameter outer circumferential wall, and an outer stepped portion. A method for manufacturing the assembly includes a press-fitting step of fitting the housing and the cover by press-fitting to form a circumferential gap that is open in an axial direction and a welding step of welding the housing and the cover at the circumferential gap.

### CROSS REFERENCE TO RELATED APPLICATION

This application is based on Japanese Patent Application No. 2020-004097 filed on Jan. 15, 2020, the disclosure of which is incorporated herein by reference in its entirety.

### TECHNICAL FIELD

The present disclosure relates to a method for manufacturing an assembly, a parts set, a method for manufacturing a fuel injection pump, and the fuel injection pump.

### BACKGROUND

Multiple components constituting an assembly are joined with each other by press-fitting and welding.

### SUMMARY

A method for manufacturing an assembly includes a press-fitting step of fitting the housing and the cover to each other and a welding step of welding the housing and the cover. The assembly includes a housing including a first assembly portion that is formed into a cylindrical shape and has an opening end and a cover including a second assembly portion that is formed into a cylindrical shape and has an opening end. One of the first assembly portion and the second assembly portion includes: (i) a small diameter inner circumferential wall, a large diameter inner circumferential wall, and an inner stepped portion that connects between the small diameter inner circumferential wall and the large diameter inner circumferential wall; or (ii) a large diameter outer circumferential wall, a small diameter outer circumferential wall, and an outer stepped portion that connects between the large diameter outer circumferential wall and the small diameter outer circumferential wall. The press-fitting step includes press-fitting the housing and the cover to each other in an axial direction to form a circumferential gap that is open in the axial direction. The circumferential gap is defined: (i) between the large diameter inner circumferential wall of the one of the first assembly portion and the second assembly portion and an outer circumferential wall of the other of the first assembly portion and the second assembly portion; or (ii) between the small diameter outer circumferential wall of the one of the first assembly portion and the second assembly portion and an inner circumferential wall of the other of the first assembly portion and the second assembly portion. The welding step includes welding the housing and the cover at the circumferential gap.

A method for manufacturing a fuel injection pump uses the method for manufacturing the assembly. The fuel injection pump is configured to inject a fuel into an internal combustion engine and includes a housing and a cover. In the method for manufacturing the fuel injection pump, the housing and the cover are joined with each other by the press-fitting step and the welding step.

A parts set includes a housing and a cover. The housing includes a first assembly portion that is formed into a cylindrical shape and has an opening end. The cover includes a second assembly portion that is formed into a cylindrical shape and has an opening end. The housing and the cover are made of material that are capable of being welded with each other. One of the first assembly portion and the second assembly portion includes: (i) a small diameter inner circumferential wall, a large diameter inner circumferential wall, and an inner stepped portion that connects between the small diameter inner circumferential wall and the large diameter inner circumferential wall; or (ii) a large diameter outer circumferential wall, a small diameter outer circumferential wall, and an outer stepped portion that connects between the large diameter outer circumferential wall and the small diameter outer circumferential wall. The first assembly portion and the second assembly portion are press-fit to each other such that a circumferential gap that is open in the axial direction is defined: (i) between the large diameter inner circumferential wall of the one of the first assembly portion and the second assembly portion and an outer circumferential wall of the other of the first assembly portion and the second assembly portion; or (ii) between the small diameter outer circumferential wall of the one of the first assembly portion and the second assembly portion and an inner circumferential wall of the other of the first assembly portion and the second assembly portion

A fourth aspect of the present disclosure relates to a fuel injection pump configured to inject a fuel into an internal combustion engine. The fuel injection pump is constituted by multiple components including the parts set.

### BRIEF DESCRIPTION OF THE DRAWINGS

FIG. 1 is a schematic view of a common rail system for which a fuel injection pump is applied.

FIG. 2 is a cross-sectional view of the fuel injection pump of a first embodiment.

FIG. 3 is an enlarged view of a damper in FIG. 2.

FIG. 4 is a schematic view of the damper viewed in a direction of an arrow IV in FIG. 3.

FIG. 5 is an enlarged view of a part V in FIG. 3 illustrating a joining configuration of the first embodiment.

FIG. 6A is a cross-sectional view of assembly portions in a comparative example 1.

FIG. 6B is a cross-sectional view of assembly portions in a comparative example 2.

FIG. 7 is a flow chart of a method for manufacturing a damper assembly of the first embodiment.

FIG. 8 is a cross-sectional view of a joining configuration of a second embodiment.

FIG. 9 is a cross-sectional view of a joining configuration of a third embodiment.

FIG. 10 is a cross-sectional view of a joining configuration of a fourth embodiment.

FIG. 11 is a cross-sectional view of a joining configuration of a fifth embodiment.

### DETAILED DESCRIPTION

To begin with, examples of relevant techniques will be described.

It has been known that multiple components constituting an assembly are joined with each other by press-fitting and welding.

A high-pressure fuel supply pump includes a functional component and a pump body defining a fuel passage. The fuel passage opens at an outer surface of the pump body. The functional component is inserted into the fuel passage and joined to the pump body in a press-fitting portion and a welding portion. The press-fitting portion is formed in the pump body by press-fitting an outer circumferential portion of the functional component into an inner circumferential portion of the fuel passage. The welding portion is disposed in a side of the press-fitting portion closer to an outer surface of the pump body.

A discharge joint and a discharge plug of the high-pressure fuel supply pump are press-fit to each other in a press-fitting portion and welded with each other in a welding portion. A closed space is defined between the press-fitting portion and the welding portion. Thus, a fume generated in welding may not be released to an atmospheric air and generate a blowhole, which reduces a quality of welding. The fume is a smoke including tiny particles and a gas vaporized in welding. The blowhole is a hollow area or a hole generated in the welding portion by capturing the fume.

The issue of releasing the fume in welding is not limited for the functional element such as the discharge joint and the discharge plug of the high-pressure fuel supply pump. That is, general assemblies including a housing and a cover that are joined by a press-fitting step and a welding step has an issue to prevent the blowhole generated by the fume in welding.

In view of this issue, it is objective of the present disclosure to provide a method for manufacturing an assembly that can improve a welding quality between the housing and the cover and a parts set used for the method.

Specifically, it is objective of the present disclosure to provide a method for manufacturing a fuel injection pump using the method for manufacturing the assembly and the fuel injection pump configured with components including the parts set.

According to a first aspect of the present disclosure, a method for manufacturing an assembly includes a press-fitting step of fitting the housing and the cover to each other and a welding step of welding the housing and the cover. The housing includes a first assembly portion that is formed into a cylindrical shape and has an opening end. The cover includes a second assembly portion that is formed into a cylindrical shape and has an opening end.

During the press-fitting step, the housing and the cover are press-fitted to each other in a fitting portion that is a partial range in the axial direction of the first assembly portion and the second assembly portion. During the welding step, the housing and the cover are welded with each other in a welding portion that is a partial range in the axial direction of the first assembly portion and the second assembly portion and adjacent to the fitting portion.

One of the first assembly portion and the second assembly portion includes: (i) a small diameter inner circumferential wall, a large diameter inner circumferential wall, and an inner stepped portion that connects between the small diameter inner circumferential wall and the large diameter inner circumferential wall; or (ii) a large diameter outer circumferential wall, a small diameter outer circumferential wall, and an outer stepped portion that connects between the large outer circumferential wall and the small diameter outer circumferential wall.

After the press-fitting step, a circumferential gap that is open in the axial direction is defined: (i) between the large diameter inner circumferential wall of the one of the first assembly portion and the second assembly portion and an outer circumferential wall of the other of the first assembly portion and the second assembly portion; or (ii) between the small diameter outer circumferential wall of the one of the first assembly portion and the second assembly portion and an inner circumferential wall of the other of the first assembly portion and the second assembly portion. That the circumferential gap is open is not limited to that the circumferential gap is open to an atmospheric air. The circumferential gap may open to an inner space that is wide enough in view of an amount of fume. The first assembly portion and the second assembly portion are welded to each other at the circumferential gap.

In the method for manufacturing the assembly in the first aspect of the present disclosure, the circumferential gap defined by the inner stepped portion or the outer stepped portion disposed in the one of the first assembly portion and the second assembly portion is welded. The fume generated in the circumferential gap in welding is released out of the circumferential gap through an opening end of the circumferential gap. As a result, a blowhole is restricted from generating and a welding quality is improved.

A second aspect of the present disclosure relates to a method for manufacturing a fuel injection pump using the method for manufacturing the assembly in the first aspect. The fuel injection pump is configured to inject a fuel into an internal combustion engine and includes a housing and a cover. In the method for manufacturing the fuel injection pump, the housing and the cover are joined with each other with a press-fitting step and a welding step.

A third aspect of the present disclosure relates to a parts set including a housing and a cover. The housing includes a first assembly portion that is formed into a cylindrical shape and has an opening end. The cover includes a second assembly portion that is formed into a cylindrical shape and has an opening end.

The first assembly portion and the second assembly portion are press-fit to each other in a fitting portion. One of the first assembly portion and the second assembly portion includes: (i) a small diameter inner circumferential wall, a large diameter inner circumferential wall, and an inner stepped portion that connects between the small diameter inner circumferential wall and the large diameter inner circumferential wall; or (ii) a large diameter outer circumferential wall, a small diameter outer circumferential wall, and an outer stepped portion that connects between the large diameter outer circumferential wall and the small diameter outer circumferential wall.

The first assembly portion and the second assembly portion are press-fit to each other such that a circumferential gap that is open in the axial direction is defined: (i) between the large diameter inner circumferential wall of the one of the first assembly portion and the second assembly portion and an outer circumferential wall of the other of the first assembly portion and the second assembly portion; or (ii) between the small diameter outer circumferential wall of the one of the first assembly portion and the second assembly portion and an inner circumferential wall of the other of the first assembly portion and the second assembly portion.

The parts set in the third aspect of the present disclosure has the same advantages as that in the first aspect with using the method for manufacturing the assembly in the first aspect. The description that the first assembly portion and the second assembly portion are press-fit to each other in the fitting portion merely describes that a property that the first assembly portion and the second assembly portion are able to fit to each other by press-fitting. That is, the description does not intend to specify a product by the manufacturing method.

A fourth aspect of the present disclosure relates to a fuel injection pump configured to inject a fuel into an internal combustion engine. The fuel injection pump is constituted by multiple components including the parts set in the third aspect.

Hereinafter, embodiment of the present disclosure will be described with reference to drawings. In the embodiments, the same reference numerals are donated to substantially the same portions and description of the same portions will be omitted. A first to fifth embodiments as a whole are referred to as present embodiments.

The present embodiments can be applied for various targets. That is, the present embodiments can relate to a final assembly of a fuel injection pump that is configured to supply a high-pressure fuel into a common rail in a diesel engine and the like. The present embodiments can relate to a damper sub assembly that constitutes a damper in the final assembly of the fuel injection pump. Further, the present embodiments can relate to a parts set including a housing and a cover that constitute a damper case of the damper sub assembly.

The present embodiments are not limited to a product and include a method for manufacturing the damper sub assembly and a method for manufacturing a fuel injection pump assembly including the damper assembly. In the following description, a target of the present embodiments is not limited to examples described above and the target can be appropriately, flexibly, and multiply interpreted.

### (Common Rail System)

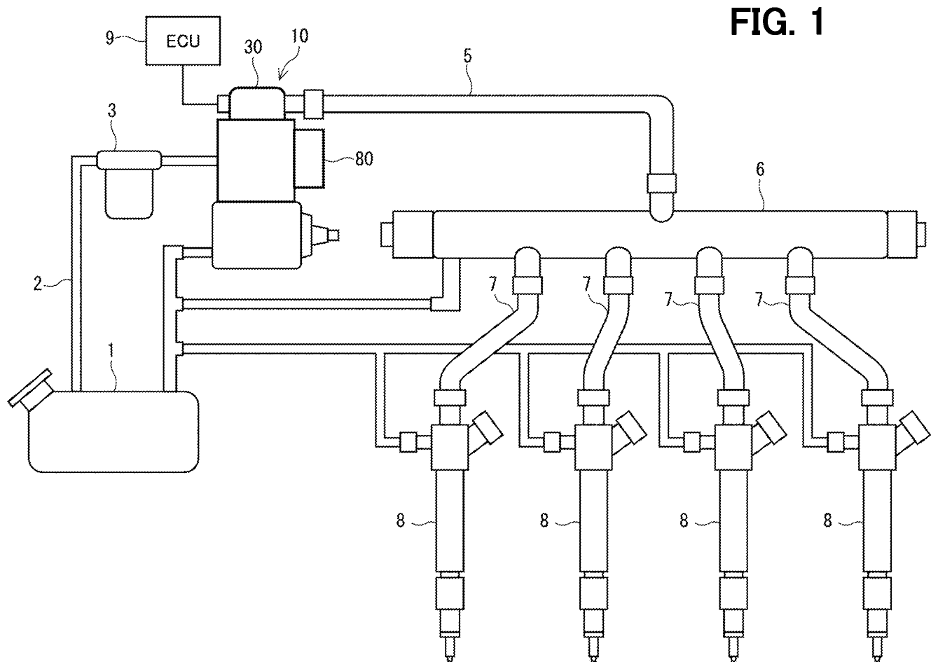

With reference to FIG. 1, an overall configuration of a common rail system for which a fuel injection pump is applied will be described. The common rail system includes a fuel tank 1, a fuel injection pump 10, a common rail 6, and multiple fuel injection valves 8 that are connected with pipes. The fuel tank 1 and the fuel injection pump 10 are connected with a low-pressure fuel pipe 2. The low-pressure fuel pipe 2 includes a fuel filter 3 configured to remove foreign matters at a middle part of the low-pressure fuel pipe 2. The fuel injection pump 10 and the common rail 6 are connected with an upstream high-pressure pipe 5 located upstream of the common rail 6. The common rail 6 and the multiple fuel injection valves 8 are connected with a downstream high-pressure fuel pipe 7 located downstream of the common rail 6.

The fuel injection pump 10 pressurizes a low-pressure fuel drawn from the fuel tank 1 and supplies a high-pressure fuel to the common rail 6. The high-pressure fuel supplied to the common rail 6 is distributed to the multiple fuel injection valves 8. In FIG. 1, the number of the fuel injection valves 8 is four. The fuel injection valves 8 are configured to inject the fuel into cylinders of an internal combustion engine. Some of the fuel does not flow to a downstream side of the fuel injection pump 10, the common rail 6, or the fuel injection valves 8 and is not consumed through an injection. The some of the fuel returns to the fuel tank 1 through a return pipe.

The fuel injection pump 10 includes an electromagnetic valve 30 and a damper 80. The electromagnetic valve 30 adjusts an amount of the fuel drawn by the fuel injection pump 10 in accordance with instructions from an ECU 9. Illustrations and descriptions on signals input and transmitted by the ECU 9 in the common rail system are omitted. The damper 80 restricts a pressure pulsation of the fuel that is supplied into the fuel injection pump 10 through a fuel inlet 41.

### (Fuel Injection Pump)

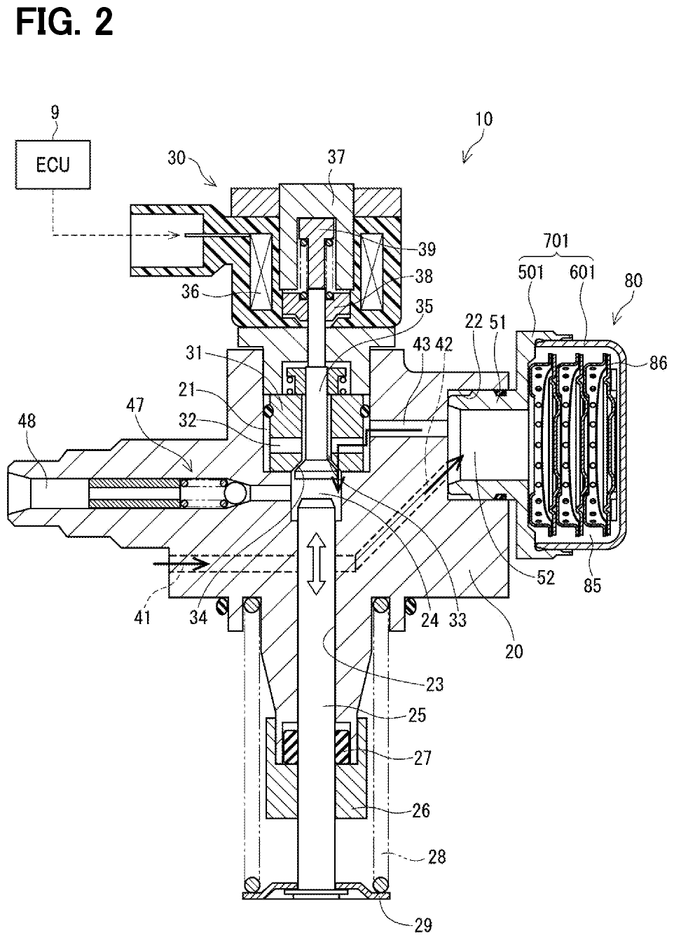

With reference to FIG. 2, an overall configuration of the fuel injection pump 10 will be described. FIG. 2 illustrates a housing 501 and a cover 601 that constitute the damper 80 of a first embodiment. The fuel injection pump 10 is configured with multiple components including a parts set 701.

In the fuel injection pump 10, various parts are assembled around a cylinder 20 as a pump body. The cylinder 20 defines a space in which the high-pressure fuel is stored and a passage through which the high-pressure fuel flows, thus a high durability against a pressure is needed in the cylinder 20. The cylinder 20 defines a plunger hole 23 and a pressurizing chamber 24. The fuel injection pump 10 changes a volume of the pressurizing chamber 24 by a plunder 25 that is inserted into the plunger hole 23 and reciprocatively moves in the plunger hole 23. Hereinafter, a side of the plunger hole 23 closer to the pressurizing chamber 24 is defined as an upper side and a side of the plunger hole 23 opposite to the pressurizing chamber 24 is defined as a lower side along an up-down direction in FIG. 2.

The plunger 25 reciprocates along the plunger hole 23 in the up-down direction. In a state in which the plunger 25 is mounted in a cylinder block and the like of the internal combustion engine, a moving direction of the plunger 25 is not strictly limited to a vertical direction and may be tilted relative to the vertical direction. The plunger 25 has a lower end connected to a seat 29 that is biased downward by a spring 28. An outer circumferential portion of the plunger 25 is sealed by an oil seal 27 fixed by an oil seal cover 26. A rotation of a camshaft (not shown) is transmitted to the lower end of the plunger 25, thereby the plunger 25 moves upward against a biasing force of the spring 28.

The low-pressure fuel drawn into the fuel injection pump 10 through the fuel inlet 41 flows into the pressurizing chamber 24 through an upstream damper passage 42, a fuel chamber 52 of the damper 80, a downstream damper passage 43, an upstream drawing valve chamber 21, and a valve passage 32 as shown in arrows. When the plunger 25 moves upward, the fuel in the pressurizing chamber 24 is pressurized. A pressure of the pressurized high-pressure fuel opens a discharge valve 47 and the high-pressure fuel is discharged to the common rail 6 through a discharge port 48.

The upstream drawing valve chamber 21 disposed on an upper side of the cylinder 20 houses a valve case 31 of the electromagnetic valve 30. The valve case 31 defines the valve passage 32 passing through the valve case 31 in a radial direction. The valve passage 32 is fluidly connected to the pressurizing chamber 24 through an opening 33. A valve body 35 adjusts an amount of the fuel drawn into the pressurizing chamber 24 by opening the opening 33 of the valve passage 32 to open the valve, and by seating on a seat portion 34 and closing the opening 33 to close the valve. A coil 36, a stator core 37, an amateur 38, and a spring guide stopper 39 that configure the electromagnetic valve 30 are disposed on an upper side of the cylinder 20.

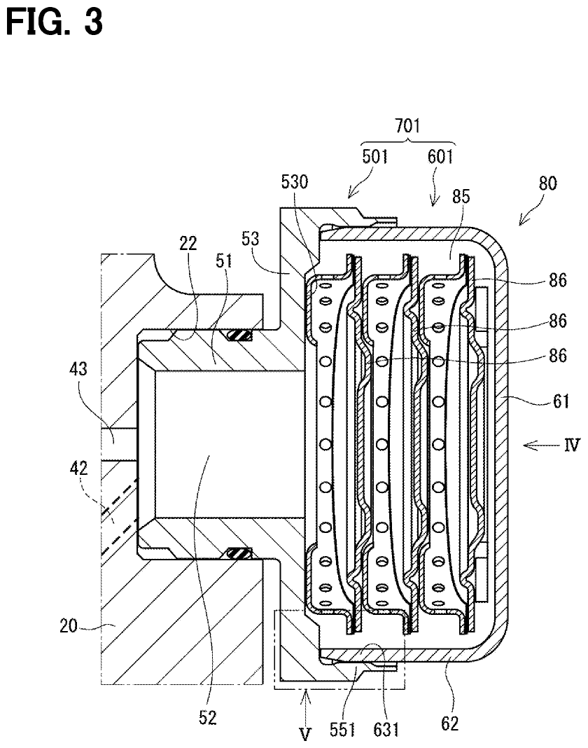

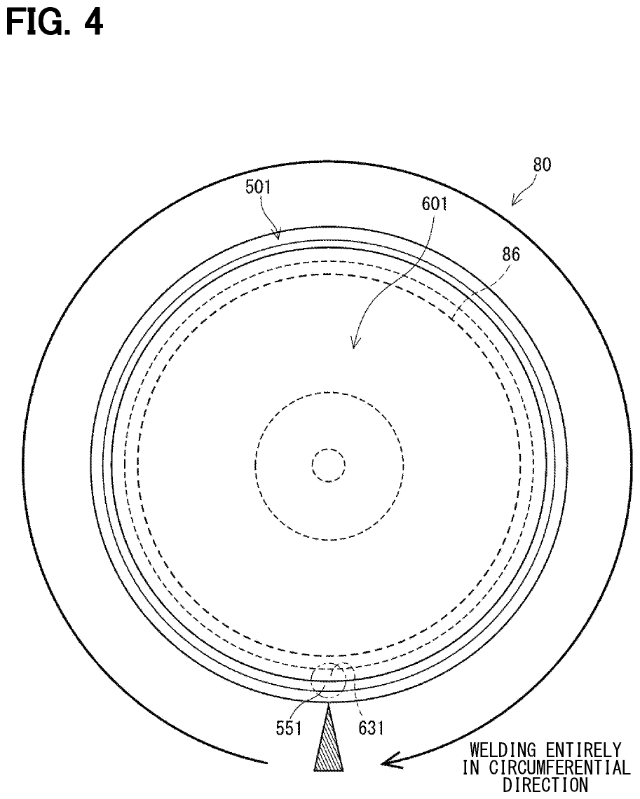

As shown in FIGS. 3 and 4, a configuration of the damper 80 will be described. The damper 80 is configured such that a pulsation damper 86 is housed in a damper chamber 85 defined by a damper case. The damper case is formed by assembling the housing 501 and the cover 601. That is, the housing 501 is a housing of the damper case and the cover 601 is a cover of the damper case. The housing 501 and the cover 601 as a whole are defined as a parts set 701 of the damper case. Each of the housing 501 and the cover 601 is made of, for example, a stainless steel.

The pulsation damper 86 is configured such that peripheral edges of a diaphragm and a plate each of which made of a metal thin plate are joined with each other. Gas is filled in the pulsation damper 86. The pulsation damper 86 elastically deforms to absorb a pulsation of the fuel. In an example shown in FIG. 3, three pulsation dampers 86 are stacked with each other and housed in the damper chamber 85. An example of the pulsation damper 86 is disclosed in, for example, JP 2018-189073 A.

The housing 501 is formed by cut processing and includes a fitting cylindrical portion 51, a supporting portion 53, and a first assembly portion 551. The housing 501 has a two stage cylindrical shape. The fitting cylindrical portion 51 is fit into a damper case fastening hole 22 of the cylinder 20 and fastened to the damper case fastening hole 22. The fitting cylindrical portion 51 defines therein a fuel chamber 52 that is fluidly in communication with the upstream damper passage 42 and the downstream damper passage 43. The fitting cylindrical portion 51 has a diameter smaller than a diameter of the first assembly portion 551. The supporting portion 53 connects the fitting cylindrical portion 51 to the first assembly portion 551 in the radial direction. The supporting portion 53 has a bottom 530 that receives the pulsation damper 86. The first assembly portion 551 is formed into a cylindrical shape and has an opening end away from the supporting portion 53.

The cover 601 is formed into a cup shape having a top plate 61 and a side plate 62 that has a cylindrical shape. The cover is formed by press processing a stainless plate. In FIG. 3, the three pulsation dampers 86 are pressed and supported between the top plate 61 of the cover 601 and the bottom 530 of the housing 501.

The side plate 62 has a tip end portion that fits into the first assembly portion 551 of the housing 501. The portion of the side plate 62 fitting into the first assembly portion 551 is referred to as the second assembly portion 631. That is, the second assembly portion 631 of the cover 601 overlaps with the first assembly portion 551 of the housing 501 in the axial direction. In the first embodiment, the first assembly portion 551 is located radially outward of the second assembly portion 631 and the second assembly portion 631 is located radially inward of the first assembly portion 551.

Since the second assembly portion 631 has an outer diameter that is slightly larger than an inner diameter of the first assembly portion 551, the cover 601 is fit into and temporarily fixed to the housing 501 by press-fitting. After the temporary fixation by press-fitting, the first assembly portion 551 and the second assembly portion 631 are entirely welded to each other in a circumferential direction while the first assembly portion 551 overlaps with the second assembly portion 631 in the axial direction. Therefore, a welded portion between the first assembly portion 551 and the second assembly portion 631 is entirely continued in the circumferential direction and the fuel in the damper chamber 85 is sealed. The welded portion will be described in detail later.

In manufacturing step of this embodiment, a sub assembly is manufactured. In the sub assembly, the housing 501 and the cover 601 are joined with each other such that the pulsation dampers 86 are housed in the damper chamber 85. The sub assembly is referred to as a damper sub assembly 80 with the same reference numeral of the damper 80. The damper sub assembly 80 has a fitting cylindrical portion 51. The fitting cylindrical portion 51 fits into and fastened to a damper case fastening hole 22 of the cylinder 20, thereby assembling the fuel injection pump 10. Specifically, the method for manufacturing an assembly in title of this disclosure relates to a method for manufacturing a damper sub assembly. In wider interpretation, the method for manufacturing an assembly in title can be interpreted as a method for manufacturing a fuel injection pump assembly including the damper sup assembly 80.

Here, the housing 501 of this embodiment is separately disposed from the cylinder 20 of the fuel injection pump 10. Thus, the high-pressure fuel pressurized by the plunger 25 does not directly contact with a joining configuration between the housing 501 and the cover 601. Therefore, a pressure durability of the joining configuration can be kept low.

Next, a detail of joining configurations between the housing and the cover of the damper sub assembly 80 will be described in every embodiments.

### First Embodiment

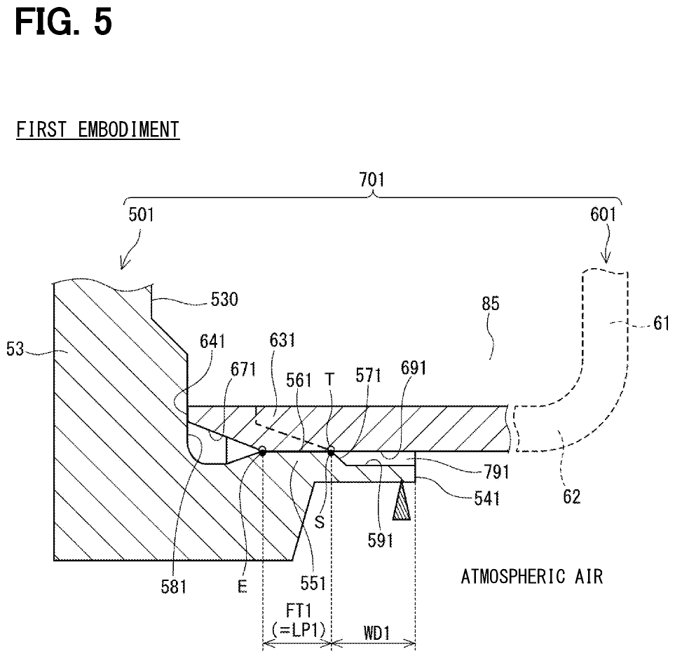

With reference to FIGS. 5 to 7, a first embodiment will be described. FIG. 5 is an enlarged view of a part V in FIG. 3. An upper side in FIG. 5 is an inside of the damper chamber 85 surrounded by the cover 601 and a lower side in FIG. 5 is an atmospheric air. Illustrations of the pulsation dampers 86 in the damper chamber 85 are omitted. The housing 501 includes the first assembly portion 551 that is formed into a cylindrical shape and has an opening end. The cover 601 is formed into a cylindrical shape and has an opening end. The second assembly portion 631 overlaps with the first assembly portion 551 in the axial direction. In the first embodiment, a portion of the side plate 62 of the cover 601 closer to the opening end serves as the second assembly portion 631.

As described above, in the first embodiment, the first assembly portion 551 is located radially outward of the second assembly portion 631 and the second assembly portion 631 is located radially inward of the first assembly portion 551. In other words, in this embodiment, the cover 601 is inserted into the opening end of the housing 501. The second assembly portion 631 overlaps with the first assembly portion 551 in the axial direction. An outer circumferential wall 691 of the second assembly portion 631 has a contact portion (or a fitting portion) FT1 that is in contact with and fits to an inner circumferential wall 561 of the first assembly portion 551. The outer circumferential wall 691 of the second assembly portion 631 has an outer diameter that is slightly larger than an inner diameter of the inner circumferential wall 561 of the first assembly portion 551 in the fitting portion FT1. As a result, the cover 601 receives a press-fitting load applied from the top plate 61 and the second assembly portion 631 can be press-fit into the first assembly portion 551.

The housing 501 includes an end surface 541. The housing 501 includes, at a portion closer to the end surface 541, a small diameter inner circumferential wall 561, a large diameter inner circumferential wall 591, and an inner stepped portion 571 connecting between the small diameter inner circumferential wall 561 and the large diameter inner circumferential wall 591. The small diameter inner circumferential wall 561 has the fitting portion (or the contact portion) FT1 and the large diameter inner circumferential wall 591 is located radially outward of the small diameter inner circumferential wall 561. During the press-fitting step, the cover 601 is inserted into the housing 501 from a start position indicated by a dashed line to an end position in which an end surface 641 of the cover 601 is in contact with a stopper surface 581 of the housing 501. The small diameter inner circumferential wall 561 has the contact portion in the axial direction that is in contact with the outer circumferential wall 691 of the second assembly portion 631. Here, a first end in the axial direction of the contact portion closer to the opening end of the housing 501 is referred to as a fitting start point S and a second end in the axial direction of the contact portion closer to the bottom 530 of the housing 501 is referred to as a fitting end point E.

The outer circumferential wall 691 of the second assembly portion 631 has a tapered portion 671 having an outer diameter that decreases toward the end surface 641. The tapered portion 671 is formed by tapering the opening end of the second assembly portion 631 on the outer circumferential wall thereof. The tapered portion 671 is connected to the outer circumferential wall 691 at a taper start point T. In the start position shown in the dashed line, the taper start point T is located at the fitting start point S. In the end position, the taper start point T of the tapered portion 671 is located substantially the same position as the fitting end point E. A fitting length (or a sliding distance) LP1 is defined as a distance in which the second assembly portion 631 is press-fit into the first assembly portion 551 while the outer circumferential wall 691 of the second assembly portion 631 is contacting with and sliding on the contact portion of the small diameter inner circumferential wall 561. In case that sizes of the first assembly portion 551 and the second assembly portion 631 are determined as described above, the sliding distance is equal to an axial length of the contact portion (i.e., the fitting portion FT1) of the small diameter inner circumferential wall 561.

After the press-fitting step, a circumferential gap 791 is defined between the large diameter inner circumferential wall 591 and the outer circumferential wall 691 of the second assembly portion 631 facing the large diameter inner circumferential wall 591. The circumferential gap 791 is open in the axial direction. In the first embodiment, the circumferential gap 791 in the first embodiment is open to an atmospheric air at one end. An area, in the axial direction, of the first assembly portion 551 and the second assembly portion 631 overlaps with the circumferential gap 791 in the radial direction is a welding portion WD1. The welding portion WD1 is located adjacent to the fitting portion FT1 in the axial direction. In welding step, the first assembly portion 551 and the second assembly portion 631 are welded with each other in the welding portion WD1.

Specifically, the circumferential gap 791 is entirely irradiated with laser in the circumferential direction from a position radially outside of the circumferential gap 791 to weld the first assembly portion 551 and the second assembly portion 631 with each other. In other words, the entire circumference of the circumferential gap is laser-welded from a position outside of the circumferential gap. A triangle mark in figures indicates a welding point. As shown in FIG. 4, a work rotates once around an axis to irradiate entirely the circumferential gap 791 with the laser in the circumferential direction. As a result, the first assembly portion 551 and the second assembly portion 631 are entirely welded with each other in the circumferential direction. In addition, a fume generated in the circumferential gap 791 in the welding step is released to the atmospheric air through the opening end of the circumferential gap 791.

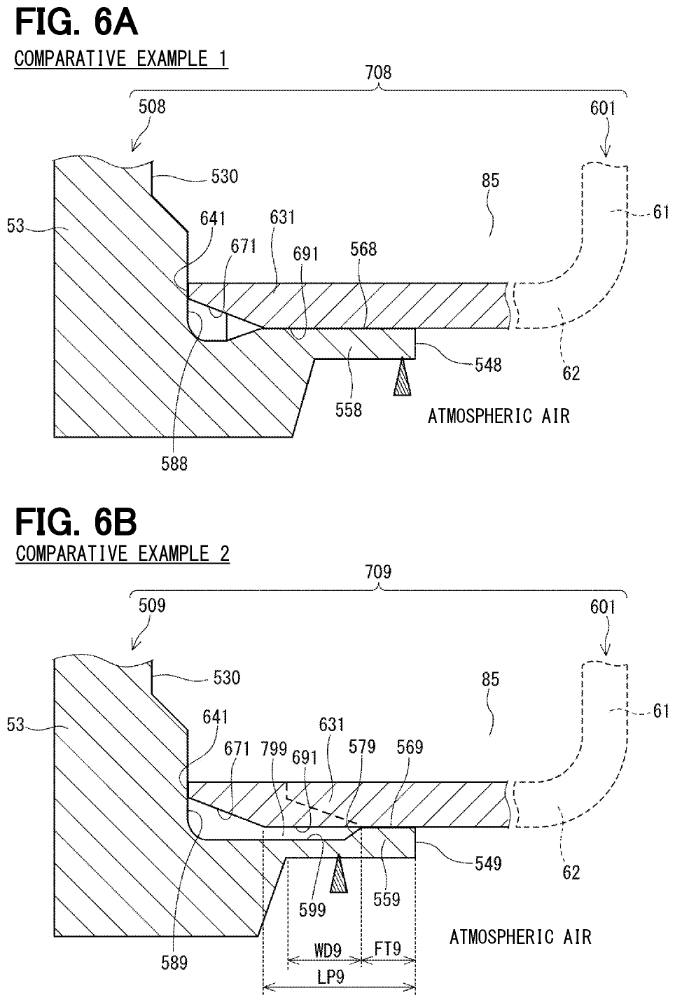

Next, with reference to FIGS. 6A and 6B, advantages of the first embodiment will be described compared to comparative examples 1 and 2. In parts sets 708, 709 of the comparative examples 1 and 2, the cover 601 is substantially the same as that of the first embodiment and configurations of housings 508, 509 are different from that of the first embodiment.

When an oil is remained in the welding step after the press-fitting step, the welding portion may have a cavity by trapping vapored compounds of the oil in welding step. Thus, it is necessary to clean the work before press-fitting step and perform press-fitting step in a dry state in which the oil is removed. However, when press-fitting is performed in the dry state, a scratch is likely to generate on a press-fitting surface. The scratch may be generated when a part is forcibly press inserted into a counterpart without smoothly sliding on the counterpart.

In a comparative example 1 shown in FIG. 6A, the housing 508 does not include an inner stepped portion and therefore a circumferential gap is not defined. Thus, a fitting portion and a welding portion cannot be distinguished from each other. In this configuration, a posture in the welding step, a positional malfunction, a scratch generation on the press-fitting surface may cause a gap, between a first assembly portion 558 and the second assembly portion 631, larger than an acceptable value and may cause a blowhole in the welding portion.

In a comparative example 2 shown in FIG. 6B, the housing 509 includes an inner stepped portion 579 located between the bottom 530 and the fitting portion FT9 of a first assembly portion 559. That is, the inner stepped portion 579 is located on an inner side of the fitting portion away from an end surface 549. The inner stepped portion 579 extends from the small diameter inner circumferential wall 569 to the large diameter inner circumferential wall 599. In a state where the cover 601 is fit into the housing 509 and the end surface 641 is in contact with the stopper surface 581, a circumferential gap 799 is defined between the large diameter inner circumferential wall 599 and the outer circumferential wall 691 of the second assembly portion 631 facing the large diameter inner circumferential wall 599.

In the comparative example 2, a start position of the tapered portion 671 of the cover 601 is the same as that in the first embodiment. In the comparative example 2, a fitting length LP9 is defined as a length in which the outer circumferential wall 691 of the second assembly portion 631 is inserted into the small diameter inner circumferential wall 569 of the first assembly portion 559 while the outer circumferential wall 691 of the second assembly portion 631 are contacting with and sliding on the small diameter inner circumferential wall 569. The press-fitting length LP9 is longer than a length in the axial direction of the fitting portion FT9. Thus, a sliding portion of the outer circumferential wall 691 of the second assembly portion 631 that slides on the small diameter inner circumferential wall 569 extends over the fitting portion FT9 and overlaps with the circumferential gap 799 in the radial direction. Thus, during the welding of the welding portion WD9, a scratch generated on a welded surface of the outer circumferential wall 691 may be larger than the acceptable value and cause a blowhole.

In addition, the circumferential gap 799 in the comparative example 2 is a closed space, thus a fume generated in welding cannot escape. Therefore, a blowhole is more likely to generate. As described above, a welding quality may decrease in the comparative examples 1 and 2.

In the first embodiment, the inner stepped portion 571 is disposed between the fitting portion FT1 and the end surface 541 of the first assembly portion 551. Thus, the fitting portion FT1 can be distinguished from the welding portion WD1 that is adjacent to the fitting portion FT1 in the axial direction. Therefore, even if the outer circumferential wall 691 of the second assembly portion 631 contacts with the small diameter inner circumferential wall 561 of the first assembly portion 551 and a scratch is generated on the outer circumferential wall 691 of the second assembly portion 631, the scratch is not exposed to the circumferential gap 791. That is, a part of the outer circumferential wall 691 processed within a tolerance is welded in the circumferential gap 791. Additionally, the circumferential gap 791 is open in one end in the axial direction. Therefore, fume is released to the outside of the circumferential gap 791. As a result, a blow hole is restricted from generating.

In the first embodiment, the fitting length LP1 of the cover 601 is determined based on a length from the start position to the end position. In other words, the fitting length LP1 is equal to the length of the contact portion that is defined as a length from a boundary between the circumferential gap 791 and the small diameter inner circumferential wall 561 (or the fitting portion FT1) to a boundary between the tapered portion 671 and the small diameter inner circumferential wall 561. That is, the fitting length LP1 can be adjusted by adjusting a position of the fitting start point S that is the boundary between the fitting portion FT1 and the circumferential gap 791. Thereby, a robustness against press-fitting can be improved. For example, in a design-testing step, the fitting length is adjusted to be a minimum length that can secure a strength against press-fitting. As a result, a productivity in a mass production can be improved.

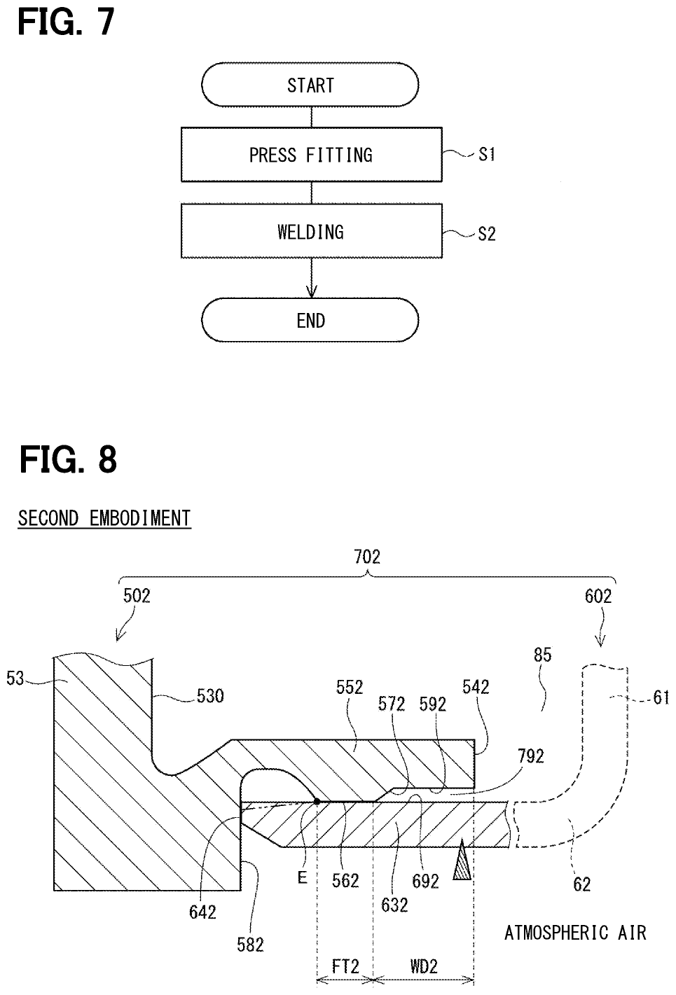

FIG. 7 is a flow chart illustrating a method for manufacturing the damper sub assembly 80 in this embodiment. In step 1 of press-fitting step, the first assembly portion and the second assembly portion are press-fit to each other. In step 2 of welding step, the circumferential gap 791 is entirely irradiated with laser in the circumferential direction from a position radially outward of the circumferential gap 791 and the first assembly portion and the second assembly portion are welded to each other.

Next, with reference to FIGS. 8 to 11 corresponding to FIG. 5 in the first embodiment, joining configurations of a second to fifth embodiment that is different from that of the first embodiment will be described.

### Second Embodiment

FIG. 8 illustrates a joining configuration between a housing 502 and a cover 602 that constitute a parts set 702 of a second embodiment. The cover 602 in the second embodiment has a cup shape similar to that of the first embodiment. Contrary to the first embodiment, a first assembly portion 552 of the housing 502 is located radially inward of a second assembly portion 632 of the cover 602 and the second assembly portion 632 is located radially outward of the first assembly portion 552. That is, the housing 502 is inserted into the opening end of the cover 602. The second assembly portion 632 overlaps with the first assembly portion 552 in the axial direction. An outer circumferential wall 562 of the first assembly portion 552 is press-fit into an inner circumferential wall 692 of the second assembly portion 632 and the outer circumferential wall 562 and the inner circumferential wall 692 are in contact with each other in a fitting portion FT2. The second assembly portion 632 has an end surface 642 and the end surface 642 is in contact with a stopper surface 582 of the housing 502 at an end position.

The first assembly portion 552 includes a large diameter circumferential wall 562, a small diameter outer circumferential wall 592 located radially inward of the large diameter outer circumferential wall 562, and an outer stepped portion 572 connecting between the large diameter outer circumferential wall 562 and the small diameter outer circumferential wall 592. The large diameter outer circumferential wall 592 has the fitting portion FT2. The outer stepped portion 572 is located between the fitting portion FT2 and an end surface 542 of the first assembly portion 552. After the press-fitting step, a circumferential gap 792 that is open at one end in the axial direction is defined between the small diameter outer circumferential wall 592 and the inner circumferential wall 692 of the second assembly portion 631 facing the small diameter outer circumferential wall 592. Specifically in this embodiment, the circumferential gap 792 is open to the damper chamber 85.

An area, in the axial direction, of the first assembly portion 552 and the second assembly portion 632 overlapping with the circumferential gap 792 in the radial direction is a welding portion WD2. The welding portion WD2 is adjacent to the fitting portion FT2 in the axial direction. During the welding step, the first assembly portion 552 and the second assembly portion 632 are welded to each other in the welding portion WD2.

In the second embodiment, the circumferential gap 792 does not open to the atmospheric air. However, a volume of the damper chamber 85 is large enough compared to a volume of fume generated through welding. Therefore, similar advantages of a configuration in which the circumferential gap 791 opens to the atmospheric air can be obtained in view of releasing the fume. In the second embodiment, since the outer stepped portion 572 is formed by processing the outer circumferential wall of the housing 502, a finishing processing is easier compared to processing an inner circumferential wall of the housing 502.

### Third Embodiment

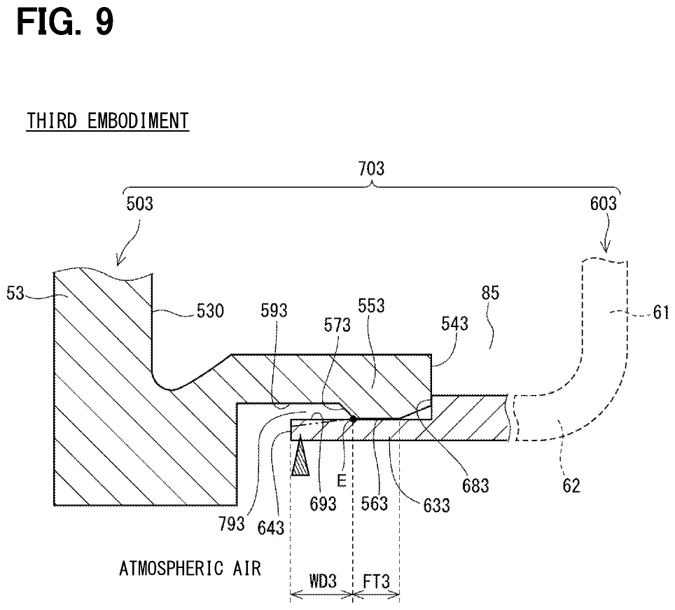

FIG. 9 illustrates a joining configuration between a housing 503 and a cover 603 that constitute a parts set 703 in a third embodiment. As with the second embodiment, a first assembly portion 553 of the housing 503 is located radially inward of a second assembly portion 633 of the cover 603 and the second assembly portion 633 is located radially outward of the first assembly portion 553 of the housing 503. That is, the housing 502 is inserted into the opening end of the housing 603. The second assembly portion 633 overlaps with the first assembly portion 553 in the axial direction. An outer circumferential wall 563 of the first assembly portion 553 is press-fit into an inner circumferential wall 693 of the second assembly portion 633.

The cover 603 of the third embodiment is formed into a cylindrical shape. The side plate 62 has a large inner diameter portion at an end facing the housing 503 and a small inner diameter portion at the other end of the side plate 62. Thus, a plate thickness of the second assembly portion 633 is reduced and the side plate 62 has a stepped surface 683 at a boundary between the large inner diameter portion and the small inner diameter portion. The stepped surface 683 of the cover 603 is in contact with an end surface 543 of the housing 503 at an end position of press fitting. In this case, the end surface 543 of the housing 503 is a stopper surface.

In the third embodiment, the first assembly portion 553 includes a large diameter outer circumferential wall 563, a small diameter outer circumferential wall 593 located radially inward of the large diameter outer circumferential wall 563, and a stepped portion 573 connecting between the large diameter outer circumferential wall 563 and the small diameter outer circumferential wall 593. The large diameter outer circumferential wall 563 has a contact portion (i.e., the fitting portion FT3) that is press-fit to and in contact with an inner circumferential wall 693 of the second assembly portion 633. The stepped portion 573 is located between an end surface 643 of the second assembly portion 633 and the fitting portion FT3. In other words, the stepped portion 573 is located on a side of the fitting portion FT3 away from the end surface 543 of the first assembly portion 553. After the press fitting step, a circumferential gap 793 is defined between the small diameter outer circumferential wall 593 and the inner circumferential wall 693 of the second assembly portion 633 facing the small diameter outer circumferential wall 593. The circumferential gap 793 is open to the atmospheric air at one end in the axial direction. The first assembly portion 553 and the second assembly portion 633 have an area in the axial direction that overlaps with the circumferential gap 793 in the radial direction. The area is a welding portion WD3. During the welding, the first assembly portion 553 and the second assembly portion 633 are welded to each other in the welding portion WD3.

In the third embodiment, the stepped portion 573 is located in an outer cylindrical wall of the housing 503, similarly to the second embodiment. Thus, a finishing processing is easier compared to processing an inner circumferential wall. The circumferential gap 793 is open to the atmospheric air compared to the second embodiment in which the circumferential gap 792 is open to the damper chamber 85. Thus, the fume can be released sufficiently in welding. Further, since a thickness of a portion of the second assembly portion 633 in the welding portion WD3 is thin, an output of the laser can be reduced.

### Fourth Embodiment

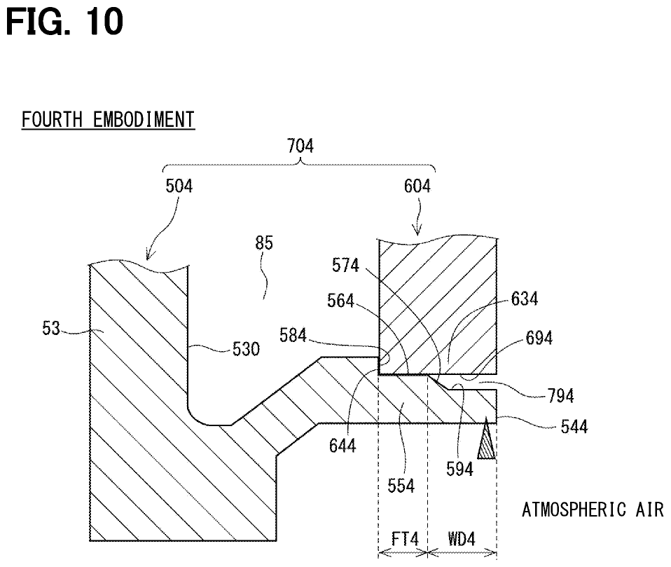

FIG. 10 illustrates a joining configuration between a housing 504 and a cover 604 that constitute a parts set 704 in a fourth embodiment. The cover 604 of the fourth embodiment does not have a cup shape that the covers of the first through third embodiments have. The cover 604 of the fourth embodiment is formed into a circular plate shape. In this embodiment, an outer circumferential wall of the circular plate shape constitutes a second assembly portion 634. The cover 604 has a circular plate surface facing the damper chamber 85 and an outer peripheral part of the circular plate surface serves as an end surface 644 of the second assembly portion 634.

In the fourth embodiment, a first assembly portion 554 is located radially outward of the second assembly portion 634 and the second assembly portion 634 is located radially inward of the first assembly portion 554. The first assembly portion 554 and the second assembly portion 634 are overlapped with each other in the axial direction. An outer circumferential wall 694 of the second assembly portion 634 is press-fit into an inner circumferential wall 564 of the first assembly portion 554 and the second assembly portion 634 and the first assembly portion 554 are in contact with each other in a contact portion (i.e., a fitting portion FT4). The housing 504 has a stopper surface 584 formed into a stepped surface. The end surface 644 of the second assembly portion 634 is in contact with the stopper surface 584 at an end position of press-fitting

The first assembly portion 554 has a small diameter inner circumferential wall 564, a large diameter inner circumferential wall 594 located radially outward of the small diameter inner circumferential wall 564, and a stepped portion 574 connecting between the small diameter inner circumferential wall 564 and the large diameter inner circumferential wall 594. The small diameter inner circumferential wall 564 has the fitting portion FT4. The stepped portion 574 is disposed between the fitting portion FT4 and an end surface 544 of the first assembly portion 554. After press fitting, a circumferential gap 794 is defined between the large diameter inner circumferential wall 594 and an outer circumferential wall 694 of the second assembly portion 634 facing the large diameter inner circumferential wall 594. The circumferential gap 794 is open at one end in the axial direction. Specifically, the circumferential gap 794 of the fourth embodiment is open to the atmospheric air. The first assembly portion 554 and the second assembly portion 634 have an area in the axial direction that overlaps with the circumferential gap 794 in the radial direction. The area is a welding portion WD4 and the welding portion WD4 is located adjacent to the fitting portion FT4 in the axial direction. In welding step, the first assembly portion 554 and the second assembly portion 634 are welded with each other in the welding portion WD4.

In the fourth embodiment, advantages similar to those of the first embodiment can be obtained and a structure of the cover 604 can be simplified.

### Fifth Embodiment

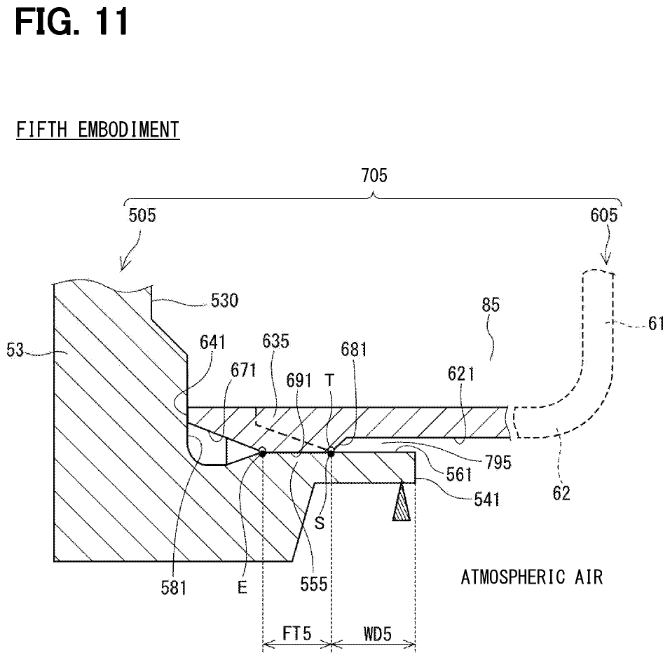

FIG. 11 illustrates a joining configuration between a housing 505 and a cover 605 that constitute a parts set 705 in a fifth embodiment. The fifth embodiment is different from the first embodiment in that a second assembly portion 635 of the cover 605 includes a large diameter outer circumferential wall 691, a small diameter outer circumferential wall 621 located radially inward of the large diameter outer circumferential wall 691, and a stepped portion 681 connecting between the large diameter outer circumferential wall 691 and the small diameter outer circumferential wall 621. As with the first embodiment, the housing 505 has a first assembly portion 555 located radially outward of the second assembly portion 635 of the cover 605. That is, the cover 605 is inserted into the opening end of the housing 505. The large diameter outer circumferential wall 691 of the second assembly portion 635 is in contact with the inner circumferential wall 561 of the first assembly portion 555 at a contact portion (or a fitting portion FT5). After the press-fitting step, a circumferential gap 795 is defined between the small diameter outer circumferential wall 621 and the inner circumferential wall of the first assembly portion 555 facing the small diameter outer circumferential wall 621. The circumferential gap 795 is open to the atmospheric air at one end in the axial direction. Therefore, advantages similar to those in the first embodiment can be obtained in the fifth embodiment.

### Other Embodiment

(a) “A method for manufacturing an assembly” in this disclosure may be used for joining a housing and a cover that constitute a different member from the damper 80 in the fuel injection pump. The method for manufacturing an assembly is not limited to a method for manufacturing the fuel injection pump and may be used for a method for manufacturing various assemblies in which a housing and a cover are joined to each other by press-fitting and welding.

(b) Similarly, “a parts set” in this disclosure is not limited to a parts set including a housing and a cover that constitute a damper case of a fuel injection pump. The parts set may be used for any case including a housing and a cover.

(c) As shown in chain two-dashed lines in FIGS. 8 and 9, the inner circumferential wall 692, 693 of the second assembly portion 632, 633 of the second and third embodiment may include a tapered portion having an inner diameter that decreases from the fitting end point E of the fitting portion FT2, FT3 to the end surface 642, 643. The tapered portion is formed by tapering the opening end of the second assembly portion 632, 693 on the inner circumferential wall 692, 693 thereof. Also in this case, a fitting length (or a sliding length) of the cover 602, 603 in which the housing 502, 502 are press-fit into the cover 602, 603 while the inner circumferential wall 692, 693 of the cover 602, 603 are sliding on the large diameter outer circumferential wall 562, 563 of the housing 502, 503 can be equal to an axial length of a contact portion of the large diameter outer circumferential wall 562,563 with the inner circumferential wall 692,693. Thus, similar advantages of the tapered portion 671 of the first embodiment can be obtained. That is, the sliding length is determined by a length from the start position to the end position. Therefore, a robustness against press fitting can be improved.

(d) In the embodiments described above, the first assembly portion 551-554 of the housing 501-504 includes the stepped portion 571-574, but the second assembly portion may include the stepped portion as shown in the fifth embodiment.

(e) A material for the housing and the cover is not limited to a stainless steel described in embodiments and may be other metal material that can be welded. Additionally, processing method such as cut processing and press processing does not matter.

The present disclosure is not limited to embodiments described above and can be variously modified in a range without departing from a gist of the present disclosure.

What is claimed is:

1. A method for manufacturing an assembly, the assembly including:
a housing including a first assembly portion that is formed into a cylindrical shape and has an opening end; and
a cover including a second assembly portion that is formed into a cylindrical shape and has an opening end, wherein
one of the first assembly portion and the second assembly portion includes:
(i) a small diameter inner circumferential wall, a large diameter inner circumferential wall, and an inner stepped portion that connects between the small diameter inner circumferential wall and the large diameter inner circumferential wall; or
(ii) a large diameter outer circumferential wall, a small diameter outer circumferential wall, and an outer stepped portion that connects between the large diameter outer circumferential wall and the small diameter outer circumferential wall,
the method comprising:
a press-fitting step of press-fitting the housing and the cover to each other in an axial direction to form a circumferential gap that is open in the axial direction and is defined:
(i) between the large diameter inner circumferential wall of the one of the first assembly portion and the second assembly portion and an outer circumferential wall of the other of the first assembly portion and the second assembly portion; or
(ii) between the small diameter outer circumferential wall of the one of the first assembly portion and the second assembly portion and an inner circumferential wall of the other of the first assembly portion and the second assembly portion; and
a welding step of welding the housing and the cover at the circumferential gap.

2. The method according to claim 1, wherein
the cover includes at least one of an end surface and a stepped surface,
the housing includes a stopper surface,
the press-fitting step includes press-fitting the first assembly portion and the second assembly portion to each other a sliding distance until the end surface or the stepped surface of the cover comes into contact with the stopper surface of the housing while:
(i) the small diameter inner circumferential wall of the one of the first assembly portion and the second assembly portion is sliding on the outer circumferential wall of the other of the first assembly portion and the second assembly portion; or
(ii) the large diameter outer circumferential wall of the one of the first assembly portion and the second assembly portion is sliding on the inner circumferential wall of the other of the first assembly portion and the second assembly portion,
the sliding distance is equal to:
(i) an axial length of a contact portion of the small diameter inner circumferential wall of the one of the first assembly portion and the second assembly portion with the outer circumferential wall of the other of the first assembly portion and the second assembly portion; or
(ii) an axial length of a contact portion of the large diameter outer circumferential wall of the one of the first assembly portion and the second assembly portion with the inner circumferential wall of the other of the first assembly portion and the second assembly portion.

3. The method according to claim 2, wherein
the opening end of the other of the first assembly portion and the second assembly portion is tapered on the outer circumferential wall thereof such that the sliding distance is equal to the axial length of the contact portion of the small diameter inner circumferential wall of the one of the first assembly portion and the second assembly portion, or
the opening end of the other of the first assembly portion and the second assembly portion is tapered on the inner circumferential wall thereof such that the sliding distance is equal to the axial length of the contact portion of the large diameter outer circumferential wall of the one of the first assembly portion and the second assembly portion.

4. The method according to claim 1, wherein
the welding step includes laser-welding an entire circumference of the circumferential gap from a position radially outside of the circumferential gap to join the first assembly portion to the second assembly portion.

5. The method according to claim 1, wherein
the press-fitting step includes inserting a portion of the cover into the opening end of the housing.

6. The method according to claim 1, wherein
the press-fitting step includes inserting a portion of the housing into the opening end of the cover.

7. A method for manufacturing a fuel injection pump including the housing and the cover according to claim 1, wherein
the cover and the housing are joined with each other by the press-fitting step and the welding step.

8. The method according to claim 7, wherein
the fuel injection pump further includes:
a plunger; and
a cylinder defining a pressurizing chamber in which the fuel is pressurized by the plunger reciprocatively moving, and
the housing is separately disposed from the cylinder.

9. The method according to claim 7, wherein
the fuel injection pump further includes a pulsation damper that restricts from generating a pulsation of the fuel flowing into the fuel injection pump through an inlet passage, and
the cover is a damper case housing the pulsation damper.

10. A parts set comprising:
a housing including a first assembly portion that is formed into a cylindrical shape and has an opening end; and
a cover including a second assembly portion that is formed into a cylindrical shape and has an opening end, the housing and the cover being made of material that are capable of being welded with each other, wherein
one of the first assembly portion and the second assembly portion includes:
(i) a small diameter inner circumferential wall, a large diameter inner circumferential wall, and an inner stepped portion that connects between the small diameter inner circumferential wall and the large diameter inner circumferential wall; or
(ii) a large diameter outer circumferential wall, a small diameter outer circumferential wall, and an outer stepped portion that connects between the large diameter outer circumferential wall and the small diameter outer circumferential wall, and
the first assembly portion and the second assembly portion are press-fit to each other such that a circumferential gap that is open in the axial direction is defined:
(i) between the large diameter inner circumferential wall of the one of the first assembly portion and the second assembly portion and an outer circumferential wall of the other of the first assembly portion and the second assembly portion; or
(ii) between the small diameter outer circumferential wall of the one of the first assembly portion and the second assembly portion and an inner circumferential wall of the other of the first assembly portion and the second assembly portion.

11. The parts set according to claim 10, wherein
a portion of the cover is press-fit into the opening end of the housing.

12. The parts set according to claim 10, wherein
a portion of the housing is press-fit into the opening end of the cover.

13. A fuel injection pump configured to inject a fuel into an internal combustion engine, the fuel injection pump comprising
the parts set according to claim 10.

14. The fuel injection pump according to claim 13, further comprising:
a plunger; and
a cylinder defining a pressurizing chamber in which the fuel is pressurized by the plunger reciprocatively moving, wherein
the housing is separately disposed from the cylinder.

15. The fuel injection pump according to claim 13, further comprising
a pulsation damper that restricts from generating a pulsation of the fuel flowing into the fuel injection pump through an inlet passage, wherein
the cover is a damper case housing the pulsation damper.

16. A method for manufacturing an assembly, the assembly including:
a housing including a first assembly portion that is formed into a cylindrical shape and has an opening end; and
a cover including a second assembly portion, wherein
the first assembly portion includes a small diameter inner circumferential wall, a large diameter inner circumferential wall, and an inner stepped portion that connects between the small diameter inner circumferential wall and the large diameter inner circumferential wall,
the method comprising:
a press-fitting step of press-fitting the cover into the opening end of the housing in the axial direction to form a circumferential gap that is open in the axial direction and is defined between the large diameter inner circumferential wall of the first assembly portion and an outer circumferential wall of the second assembly portion; and
a welding step of welding the housing and the cover at the circumferential gap.
